(19) United States
(12) Patent Application Publication
(10) Pub. No.: US 2005/0160767 A1
(43) Pub. Date: Jul. 28, 2005

(54) Horizontal sheet movement control in drawn glass fabrication

(76) Inventor: Robert Novak, Lexington, KY (US)

Correspondence Address: VOLENTINE FRANCOS, P.L.L.C., 2 Meridian Boulevard, Wyomissing, PA, 19610, US

(21) Appl. No.: 10/766,439

(22) Filed: Jan. 28, 2004

(51) Int. Cl. C03B 17/06

(52) U.S. Cl. 65/29.17; 65/29.21; 65/53; 65/195; 65/162

(57) ABSTRACT

A method of providing a glass sheet of substantially uniform thickness across a width includes vertically drawing a glass. The method also includes controlling a mass, or a viscosity of glass from an isopipe, or both, to substantially eliminate horizontal movement of the glass sheet. An apparatus for carrying out the methods is also described. The apparatus includes a heating element and cooling jets to control the viscosity, and a mechanism to tilt the isopipe to control the mass.

### BACKGROUND

Display devices are used in a variety of applications. For example, glass displays are used in active matrix liquid crystal display (AMLCD) glass substrates used in thin film transistor liquid crystal displays (TFT-LCD) for notebook computers, flat panel desktop monitors, LCD televisions, and Internet and communication devices, to name only a few.

In many display devices, such as those referenced above, it is useful to incorporate electronic components directly onto the glass substrate used in the display device. Often, these are TFTs, which are complementary metal oxide semiconductor (CMOS) devices. In these applications, it is beneficial to form the semiconductor structure directly on the glass material of the display.

Thus, many LCD displays often comprise a glass substrate with the transistors formed over the glass substrate, and beneath a layer of LC material. The transistors are arranged in a patterned array, and are driven by peripheral circuitry to provide desired voltages to orient the molecules of the LC material in the desired manner. The transistors are essential components of the picture elements (pixels) of the display.

As can be appreciated, variation in the thickness of the glass panel, or defects in the glass panel will result in a variation of the spacing of the transistors and the pixels. This can result in distortion in the display panel. If the magnitude of any of the variation in the spacing is too great, the display quality may be deleteriously impacted.

As such, in LCD and other glass display applications, it is exceedingly beneficial to provide glass substrates that are within acceptable tolerances for thickness and defects to avoid at least the problems of warped glass discussed above.

What is needed therefore is a method of forming substantially defect-free and substantially uniformly thick glass that addresses at least the issues presented above.

### SUMMARY

In accordance with an example embodiment, a method of fabricating drawn glass includes providing an isopipe and providing glass to the isopipe. The method also includes measuring a parameter at a first portion and at a second portion of a glass sheet drawn from the isopipe, and maintaining a ratio of the parameter at the first portion to the parameter at the second portion to within a predetermined range.

In accordance with another example embodiment, an apparatus for fabricating drawn glass sheets includes an isopipe and a device a device which adjusts the temperature of glass. The device selectively heats and/or cools the glass that overflows the trough of the isopipe. The apparatus also includes a controller, which selectively adjusts the device to maintain a ratio of the viscosity of the first side of the isopipe to a second side of the isopipe is within a prescribed range.

In accordance with another example embodiment, an apparatus for fabricating drawn glass sheets includes an isopipe and a controller, which selectively tilts the isopipe to maintain a ratio of a mass of a glass sheet on a first side to a second side of the glass sheet is within a prescribed range.

In accordance with another example embodiment, a method of providing a glass sheet of substantially uniform thickness across a width of the glass sheet includes vertically drawing glass; and controlling a mass and a viscosity of the glass from an isopipe to substantially eliminate horizontal movement of the glass sheet.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a perspective view of an isopipe in accordance with an example embodiment.

FIG. 2a is a perspective view of the flow of glass from an isopipe in accordance with an example embodiment.

FIG. 2b is a cross-sectional view of the isopipe of FIG. 2a showing the glass flow.

FIG. 3 is a perspective view of an apparatus for fabricating glass sheets in accordance with an example embodiment.

### DETAILED DESCRIPTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the example embodiments described herein are drawn to methods and apparati used to fabricate glass sheets for use in display devices. In accordance with example embodiments, the apparati and methods provide control of the viscosity of the glass and the mass of flowing glass. This control fosters the pulling or drawing of sheet glass in a stable manner and substantially without horizontal movement. As a result, breakage is reduced and the glass sheets or substrates formed have a uniformity of thickness across the quality area of approximately 12.0 μm to approximately 2.0 μm or less. Beneficially, the uniformity of thickness is less than approximately 5.0 μm to approximately 1.0 μm or less across the quality area of the sheet of glass. Furthermore, any defects across the quality area of the sheets of glass are less than approximately 1.0 μm in diameter or depth.

Moreover, in accordance with an example embodiment, the stress levels of the glass sheets fabricated by the methods and apparati of example embodiments are less than approximately 0 psi to approximately 200 psi. As will be readily apparent to one of ordinary skill in the imaging arts, low stress levels in glass substrates used as display panels substantially reduces image distortion due to pixel misalignment. To wit, after being cut to size the glass substrate exhibits distortion of less than approximately 2.0 μm.

As will become clearer as the present description proceeds, the glass thickness and stress are maintained to within beneficial ranges by maintaining the viscosity across the glass to within a desirable range, or by providing a uniform mass balance between each half of the sheet during forming of the glass sheet, or both.

In accordance with one beneficial embodiment, the viscosities of the glass are measured at two regions, and a ratio of the measured viscosities is determined. A desired ratio is maintained by selectively altering the temperature of the glass as it emerges from the isopipe. This alteration may be accomplished by heating the glass with heating elements within the muffle, or using cooling elements at the root, or both.

According to another example embodiment, the viscosities are measured indirectly by measuring the glass temperature at selected locations of the glass sheet. These measurements may be made using a suitable temperature measuring device such as a thermometer, thermocouple or thermistor, each of which is well-known in the art.

According to another example embodiment, the thickness is also maintained by varying the mass of the glass that emerges to one side or the other of the isopipe. These and other example embodiments as well as other aspects thereof are described in further detail herein.

According to yet another example embodiment, uniform mass balance between the two halves of the glass sheet may be provided by maintaining a ratio of the mass at each half of the glass sheet within a prescribed range. A uniform balance of the mass to maintain this ratio may be effected by delivering more or less glass to one side of the sheet as needed during drawing. This can be effected by adjusting the viscosity at one end of the isopipe, or by tilting the isopipe to provide more glass per unit time to the particular isopipe end, or a combination thereof.

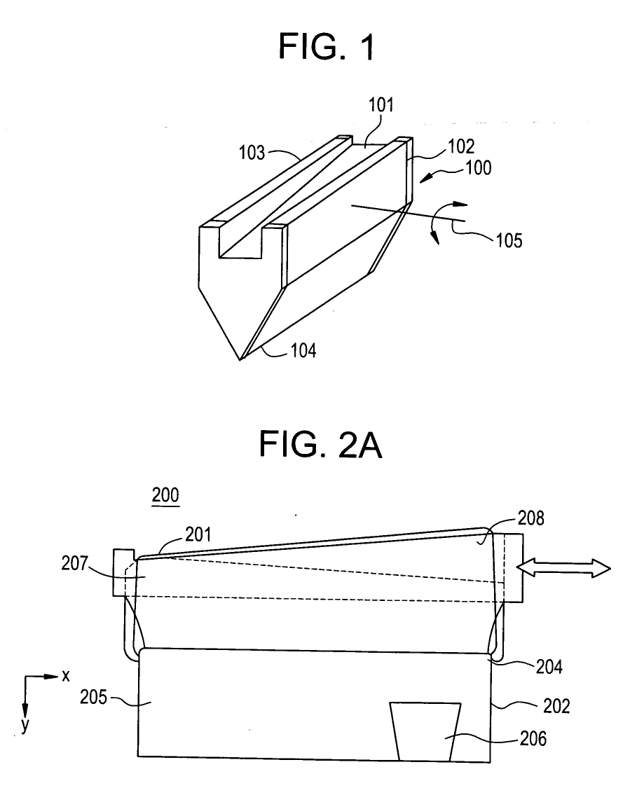

FIG. 1 shows an isopipe 100 in accordance with an example embodiment. The isopipe 100 includes a trough 101 into which melted glass is introduced from an input (not shown in FIG. 1). The glass overflows both sides 102 and 103 of the isopipe 101, and the glass from each side then joins at the point of the isopipe, commonly called the root 104. The isopipe 100 may be disposed in a muffle (not shown in FIG. 1), which may include an input for receiving the glass. In keeping with certain example embodiments described herein, the muffle may also include heating elements that heat the glass to maintain a desired ratio of the viscosity of the glass on the inlet half of the glass sheet to the compression half of the glass sheet to within a desired range; and to maintain a ratio of the mass of glass on the inlet half of the glass sheet to the compression half of the glass sheet to with in a desired range. It is noted that while details germane to the example embodiments are described, because many other details of the flow of glass over an isopipe are well-known in the art, certain details are omitted so as to not obscure the description of the example embodiments.

In addition to the heating elements, axial rotation of the isopipe 100 may be carried out to ensure that a uniform mass balance is maintained on one half relative to the other half of the sheet of glass. (It is noted that herein the ‘halves’ are determined by an imaginary line that equally bisects the glass.) This rotation may be about an axis 105 that is substantially orthogonal to the sides 102, 103 at the point shown, and is through the center of mass of the isopipe. The rotation, which is shown by the arrows about the axis 105, amounts truly to a tilting action.

As will become clearer as the present description continues, in operation, if the uniform balance of mass to each end of the isopipe may be effected by tilting the isopipe 100 about the axis 105, resulting in a greater quantity of glass' (i.e., a greater mass per unit time) being delivered to the side of the glass sheet that requires more glass flow in order to maintain the vertical rate movement of the glass substantially equally on each side.

In addition to or as an alternative to the ‘tilting’ motion of the isopipe, the flow rate of the glass on one side or the other from the isopipe may be controlled by selectively altering the viscosity of the glass on one side by providing a heating differential as referenced previously. Ultimately, by the tilting of the isopipe, or the application of heat, or both, the control of the flow of glass to be substantially equal on both ends of the isopipe 100 substantially prevents horizontal movement of the sheet glass during the drawing process. This improves the uniformity of thickness across the quality area of the glass, reduces breakage, and reduces stress in the final product.

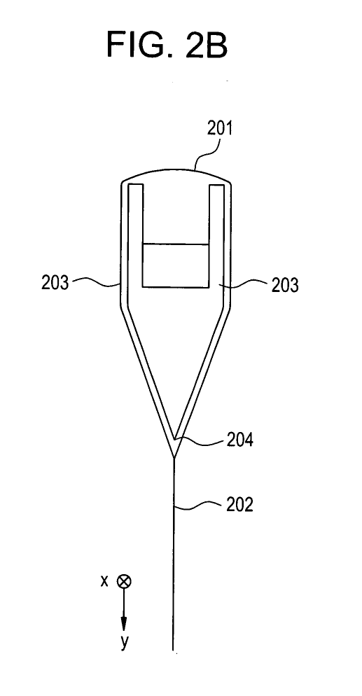

FIGS. 2a and 2b show glass 201 in the liquid state in the isopipe 200. As referenced above, beneficially the glass 201 overflows the sides 203 of the isopipe and travels in the vertical (y-direction). The glass 201 traversing each side 203 of the isopipe 200 rejoins to form a glass sheet 202. The glass sheet is pulled initially by end pulling rolls (not shown in FIGS. 2a and 2b), and ultimately in the y-direction. In accordance with the example embodiments described in detail herein, by controlling the mass per unit volume to each end 205, 206 of the glass from the isopipe 200, the glass sheet 202 is substantially prevented from significant movement in the x-direction, which is in the horizontal direction. To this end, the motion of the glass sheet in the x-direction, often referred to as walking can result in one or more of: breakage of the sheet and the attendant reduction in yield; the unacceptable variation in the thickness from one side 205 (or half) to the other side 206 (or half) of the quality area of the sheet; an unacceptable stress in the glass.

It is noted that walking refers to a swinging movement of the sheet in a manner similar to that of a pendulum. From the vantage point of the width of the sheet, the weight on the end of the pendulum would be in the same plane as the sheet of glass. It is further noted that walking does not normally occur through the direction of the thickness of the sheet (z-direction in the embodiments of FIGS. 2a and 2b). Walking can be caused by a number of factors, but is primarily due to horizontal movement (x-direction) of the glass sheet during drawing caused by uneven flow of glass on one end 207 or the other 208 of the isopipe 200.

Often, the differential in the flow from one end to the other of the isopipe results from a gradient in the temperature of the glass, and thus its viscosity. The side of the glass sheet 200 that has less viscous glass will have a greater flow rate than the other side, and will deliver more glass (i.e. a greater mass) in the same amount of time. This will result in a pendulum-type motion and, ultimately, breakage due to stress; or an unacceptable differential in thickness, and/or unacceptable stress in the final glass sheet. Alternatively, or additionally, this differential in flow results from excess mass per unit time being delivered at one end of the isopipe, creating the identical problem.

In accordance with example embodiments, the isopipe may be tilted to substantially eliminate the differential in the rate of delivery of glass between the sides 207, 208, or the heating or cooling elements may be adjusted to increase or reduce the viscosity of the glass on one side to alter the rate of flow; or a combination of tilting, heating and cooling may be effected. Ultimately, the control measures of the example embodiments maintain a substantially uniform balance of the mass of glass delivered between each half of the glass sheet 207, 208. (It is noted that the ‘halves’ are determined by an imaginary line in the y-direction that equally bisects the glass.) This results in the movement of the entire sheet of glass 202 at the same rate of speed in the vertical (y-direction) by application of the pulling rolls (not shown in FIG. 2a), with substantially no horizontal (x-direction) movement of the glass sheet.

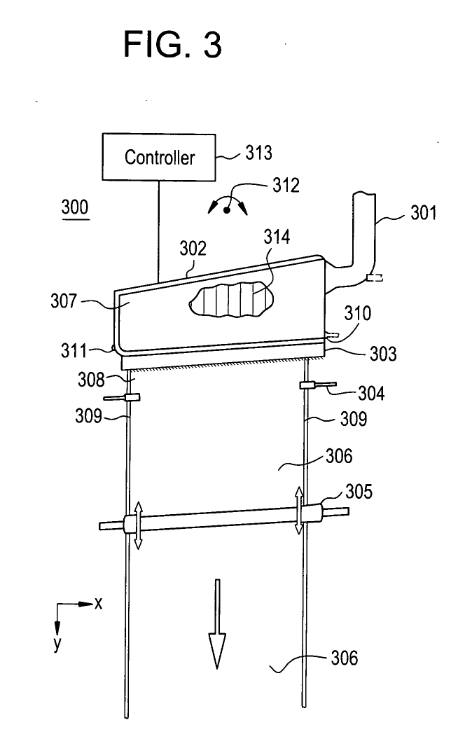

FIG. 3 shows a glass sheet drawing apparatus 300 in accordance with exemplary embodiment. The apparatus 300 includes an input 301, which delivers molten glass to an isopipe 302. The isopipe is substantially surrounded by a muffle 307 that includes heating elements that are used to control the viscosity of the glass that flows from the isopipe. Additionally, air tubes 303 may be used to provide cooling at the root 302.

The glass delivered from the input overflows the isopipe in a manner described in connection with FIGS. 2a and 2b, and emerges as glass 308, where it is grabbed by end pulling rolls 304. The end pulling rolls 304 are useful in preventing attenuation of the glass 308, which is in a semi-fluid state. These end pulling rolls 304 thus foster the formation of the glass 308 into a glass sheet 306. Additionally, the end pulling rolls 304, which are metal and thus require cooling, engage only the edge of the glass and form a bead 309 on either edge of the glass. As is well known, the bead has a thickness of approximately 2.0 to 2.5 times the thickness of the quality area of the glass sheet, and has a width (x-direction) of approximately 25 mm to 50 mm in a glass sheet having an overall width of 1500 mm. Moreover, it is noted that the quality area of the glass is between the beads 309.

The apparatus 300 also includes at least one pair of pulling rolls 305. Each of the pulling rolls 305 engages the outer edge of the glass (e.g., at the bead 309) on either side of the glass sheet and pulls the glass through at a particular vertical (y-direction) speed. As is well known in the art, the vertical velocity at which the glass is pulled by the pulling rolls dictates the thickness of the glass sheet formed. For example, in accordance with an example embodiment, glass sheets having a thickness in the quality area on the order of approximately 0.25 mm to approximately 3.0 mm, the pulling rolls rotate at a rate sufficient to propel the glass at a velocity of approximately 300 ipm to approximately 20 ipm, respectively. It is noted that pulling rolls as described in U.S. Patent Publication 2003/0181302 A2 to Kaiser, et al. may be used. The entire disclosure of this publication is specifically incorporated herein by reference.

As can be appreciated, the pulling rolls 305 are useful in providing a coarse adjustment to the thickness of the glass sheet. Fine adjustment may be provided by the controlled cooling of the glass as it emerges from the isopipe using the air tubes 303. These air tubes 303 illustratively number 5500 across a 1.3 m width, and selectively supply air to cool the glass and change its viscosity in a very controlled manner. It is noted that it is useful to balance the air supplied to each side of the glass from the isopipe. If, however, it is necessary, the air to one end or half of the glass sheet may be increased or decreased to properly modify the viscosity.

In keeping with the example embodiments, the pulling rolls form a glass sheet 306 having a substantially uniform thickness across the width of the quality area of sheet. Moreover, the reduced level of defects and stress of the glass referenced above are exceedingly useful, if not required, of glass substrates for applications such as TFT LCD displays. These are achieved using the glass flow control methods and apparati of the example embodiments.

In accordance with an example embodiment, the horizontally movement (x-direction) of the glass sheet 306 is minimized or substantially eliminated, and the uniformity of the mass of the glass is substantially balanced by altering the amount of glass delivered from a first side 310 and a second side 311 of the isopipe 302 by physically tilting the isopipe 302, or by varying in the heat to the first side 310 or the second side. As to the former, the tilting of the isopipe about the axis 312 is effected by a suitable motor device (not shown), such as a stepper motor. As to the latter, the temperature, and thus the viscosity may be altered by varying the output of heating elements.

In an illustrative embodiment, tilting of the isopipe is done by lowering or raising the compression end (opposite for the inlet end, which is the end glass enters the isopipe) of the muffle. A known motor and jack-screw system is employed for the lowering and raising movement.

In an example embodiment, a controller 313 is connected to the heating elements 314 (shown through a cutaway of the muffle 307) of the isopipe, the tilting mechanism of the isopipe, and the air tubes of the isopipe. This controller 313 alters the tilt, heating and air flow in response to input commands from an operator, or from feedback from sensors, or both. It is noted that the controller 313 may be a known or standard electronic device, such as a microcomputer or application specific integrated circuit (ASIC) programmed to effect the changes in tilt, heating and air flow. As such, further details of the controller are omitted so as to not obscure the description of the example embodiments.

Usefully, the mass of the glass on one side of one half of the glass sheet 306 to the other is maintained to within a defined ratio. In accordance with an example embodiment, this ratio is in the range of approximately 0.9 to approximately 1.1. If the ratio of the mass of the glass on the inlet half 310 of the glass sheet to the compression half 311 lies outside the range of 0.9 to 1.1, the vertical speed of the glass sheet 306 at one side will be unacceptably greater than (or less than) the other side resulting in a deleterious level of horizontal movement.

Similarly, in accordance with example embodiments, the ratio of the viscosity of the glass on the first side 310 to the second side 311 is maintained between approximately 0.9 and approximately 1.1. If the ratio of the viscosity of the glass on the first side 310 to the second side 311 lies outside the range of approximately 0.9 to approximately 1.1, the differential in the vertical speed of one side to the other will result in an unacceptable degree of horizontal movement.

In accordance with an example embodiment, the mass is determined by measuring the thickness of the glass across its width and calculating the mass on one half and the other. From here the ratio may be calculated. The measuring of the thickness may be carried out using well-known laser metrology techniques, or other techniques well-known in the art. Alternatively, the mass in the beads 309 on each side of the glass sheet is measured after the glass is cut. The ratio of the weight (mass) of segments of equal length is calculated, and if the ratio lies outside the referenced range, remedial measures described herein are taken to return the ratio to within the referenced range.

In yet another example embodiment, the heating elements may be used to maintain the desired viscosity ratio. To this end, with the type of glass known, and data from other glass sheet fabrication processes at hand, the temperature of the glass may be determined from the settings of the heating elements. From the temperatures, the viscosities at each end can be determined in-situ, and the ratio of the viscosity on each side can be determined. In an example embodiment the ratio of the viscosity of the glass of the first side 310 to the second side is maintained in the range of approximately 0.9 to approximately 1.1.

In accordance with an example embodiment, the mass and thermal conditions may be altered by tilting the isopipe, and by altering the settings of the heating elements, so that the ratio of the mass of the glass delivered from the isopipe to the inlet half 310 of the glass sheet to mass delivered to the compression half of the glass sheet 311 is maintained to between approximately 0.9 and approximately 1.1; and the ratio of the viscosity of the glass of the inlet half 310 of the glass sheet to the compression half of the glass sheet is in the range of approximately 0.9 to approximately 1.1.

In accordance with another example embodiment, the balance of the air from air tubes 303 used to control the thickness may be used as a measure of the uniformity of the mass balance on the inlet half 310 of the glass sheet and the compression half of the glass sheet 311. To this end, in accordance with an example embodiment the balance of the sum of the air on the inlet half and the compression half of the isopipe is maintained to within a ratio of approximately 0.9 to approximately 1.1. If this ratio falls outside of this range, the altering of the mass of glass delivered to the inlet half of the glass sheet or the compression half of the glass sheet is adjusted as needed by tilting the isopipe, or the variation of the heating elements, or both are carried out until the ratio is within the prescribed range.

In keeping with the example embodiments, mass and thermal conditions are controlled so that movement in the horizontal direction of a vertically drawn glass sheets is minimized, if not substantially eliminated. Beneficially, the thickness of the glass formed is substantially uniform across the quality portion of the glass, and the stress in the glass is minimized. Finally, scoring is facilitated with less breakage, and the yield is improved in a production environment.

The example embodiments having been described in detail, it is clear that modifications of the invention will be apparent to one having ordinary skill in the art having had the benefit of the present disclosure. Such modifications and variations are included in the scope of the appended claims.

1. A method of fabricating a drawn glass sheet, the method comprising:
providing an isopipe;
providing glass to the isopipe;
measuring a parameter at a first portion and at a second portion of a glass sheet drawn from the isopipe, and maintaining a ratio of the parameter at the first portion to the parameter at the second portion to within a prescribed range.

2. A method as recited in claim 1, wherein the parameter is the viscosity.

3. A method as recited in claim 1, wherein the parameter is the mass.

4. A method as recited in claim 2, wherein the viscosity is indirectly determined by measuring the temperature of the glass at the first and second portions.

5. A method as recited in claim 1, wherein the ratio is from approximately 0.9 to approximately 1.1.

6. An apparatus for fabricating drawn glass sheets, comprising:
an isopipe;
a device which adjusts the temperature of glass, by selectively heating or cooling glass that overflows the trough of the isopipe; and
a controller, which selectively adjusts the device to maintain a ratio of the viscosity of the on a first side of the isopipe to a second side of the isopipe is within a prescribed range.

7. An apparatus as recited in claim 6, wherein the viscosity is maintained by maintaining a first temperature of the glass on the first side and maintaining a second temperature of the glass at a second side.

8. An apparatus as recited in claim 7, wherein the first temperature and the second temperature are maintained by heating the glass with a heater.

9. An apparatus as recited in claim 8, wherein the first and second temperatures are maintained by setting the heater to particular settings.

10. An apparatus as recited in claim 7, wherein the first temperature and the second temperature are maintained by cooling the glass with forced air.

11. An apparatus as recited in claim 6, wherein the prescribed range is from approximately 0.9 to approximately 1.1.

12. An apparatus for fabricating drawn glass sheets, comprising:
an isopipe;
a controller, which selectively tilts the isopipe to maintain a ratio of a mass of a glass sheet on a first side to a second side of the glass sheet is within a prescribed range.

13. An apparatus as recited in claim 12, wherein the selective tilting is effected based on a first mass of glass from the first side and a second mass from the second side.

14. An apparatus as recited in claim 12, wherein the prescribed range is between approximately 0.9 and approximately 1.1.

15. An apparatus as recited in claim 12, wherein the first side is an inlet side, and the second side is a compression side.

16. An apparatus as recited in claim 13, wherein the first mass and the second mass are taken from the glass after forming, and the data are used in subsequent fabrication sequences.

17. A method of providing a glass sheet of substantially uniform thickness across a width the method, comprising:
vertically drawing a glass; and
controlling a mass or a viscosity, or both, of the glass from an isopipe, or both, to substantially eliminate horizontal movement of the glass sheet during the drawing.

18. A method as recited in claim 17, wherein the controlling further comprises determining a ratio of a mass of a first half to a mass of a second half.

19. A method as recited in claim 18, wherein the ratio is in the range of approximately 0.9 to approximately 1.1.

20. A method as recited in claim 17, wherein the controlling further comprises determining a ratio of the viscosity at a first half to the viscosity at a second half.

21. A method as recited in claim 20, wherein the ratio is in the range of approximately 0.9 to approximately 1.1.

22. A method as recited in claim 17, wherein the mass is controlled by selectively tilting the isopipe to maintain a ratio of a mass of a glass sheet on the inlet half of the isopipe and the compression half of the isopipe to within a prescribed range.
